(19) United States
(12) Patent Application Publication
(10) Pub. No.: US 2021/0036476 A1
(43) Pub. Date: Feb. 4, 2021

(54) METHOD OF MANUFACTURING ONE-PIECE CONNECTOR ASSEMBLY

(71) Applicant: LUXSHARE PRECISION INDUSTRY CO., LTD., Shenzhen (CN)

(72) Inventors: Huabing Li, Shenzhen (CN); Hong Chi, Shenzhen (CN)

(73) Assignee: LUXSHARE PRECISION INDUSTRY CO., LTD., Shenzhen (CN)

(21) Appl. No.: 16/943,372

(22) Filed: Jul. 30, 2020

(30) Foreign Application Priority Data
Aug. 2, 2019 (CN) 201910713550.0

(51) Int. Cl. H01R 43/20; H01R 12/77; H01B 7/04; H01R 12/61

(52) U.S. Cl. CPC H01R 43/205; H01R 12/613; H01B 7/04; H01R 12/771

(57) ABSTRACT

A method of manufacturing a one-piece connector assembly includes following steps: S1: providing a first semi-finished product of the connector assembly, the first semi-finished product including a first connector, a second connector and a wire connecting the first connector and the second connector; S2: providing a molded first-half outer mold; S3: assembling the first semi-finished product and the first-half outer mold together to form a second semi-finished product; and S4: putting the second semi-finished product into a forming mold and forming a second-half outer mold, thereby achieving the one-piece connector assembly. As a result, it reduces the difficulty of each forming. In addition, since the wire can be covered and protected by the first-half outer mold, the wire bias during the second forming is not easy to occur and the yield of the product is improved.

### CROSS-REFERENCE TO RELATED APPLICATION

This patent disclosure claims a priority of a Chinese Patent Application No. 201910713550.0, filed on Aug. 2, 2019 and titled “METHOD OF MANUFACTURING ONE-PIECE CONNECTOR ASSEMBLY”, the entire content of which is incorporated herein by reference.

### TECHNICAL FIELD

The present disclosure relates to a method of manufacturing a one-piece connector assembly, which belongs to a technical field of cable connectors.

### BACKGROUND

Existing cable connector products are usually manufactured by over-molding outside the wires which have outer covers, and over-molding process requires sealants on the outer covers of the wires. For the purpose of design or some special applications, more and more customers choose to use over-molding not only to cover the connector, but also to cover the wire during the integral/one-piece molding. In the current one-piece molding methods, a) the molding material is silicone; b) the molding process is a solid silicone molding process.

However, these molding methods have the following disadvantages:

(1) complicated processing. Solid silicone molding mainly needs the following processes: raw material preparation, vulcanizing agent, rubber mixing, cutting, hot press molding, trimming, post-processing, inspection, packaging etc.

(2) higher cost. Solid silicone molding and processing are complicated, and the processing cost is high. The cost of silicone raw materials is relatively high as well.

(3) high defect rate. Silicone molding requires that the product is sandwiched between two silicone sheets and the silicone temperature is melted at the mold temperature. However, during the melting of silicone, the wire of the product is prone to deflection, which results in the wire being exposed after molding and results in defects.

### SUMMARY

An object of the present disclosure is to provide a method of manufacturing a one-piece connector assembly which is easy to form and has a high yield.

To achieve the above objective, the present disclosure adopts the following technical solution: a method of manufacturing a one-piece connector assembly including following steps:

S1: providing a first semi-finished product of the connector assembly, the first semi-finished product including a first connector, a second connector and a wire connecting the first connector and the second connector;

S2: providing a molded first-half outer mold;

S3: assembling the first semi-finished product and the first-half outer mold together to form a second semi-finished product; and

S4: putting the second semi-finished product into a forming mold and forming a second-half outer mold, thereby achieving the one-piece connector assembly. The one-piece configuration means that the first-half outer mold and the second-half outer mold have no gaps between the wire and the first and the second connectors.

As a further improved technical solution of the present disclosure, the first-half outer mold in the step S2 includes a first receiving portion to partially cover the first connector, a second receiving portion to partially cover the second connector, and a third receiving portion to partially cover the wire.

As a further improved technical solution of the present disclosure, the second-half outer mold in the step S4 includes a fourth receiving portion to partially cover the first connector, a fifth receiving portion to partially cover the second connector, and a sixth receiving portion to partially cover the wire.

As a further improved technical solution of the present disclosure, the first connector includes a first insertion portion, the second connector includes a second insertion portion, the first receiving portion and the fourth receiving portion jointly cover other parts of the first connector except the first insertion portion, the second receiving portion and the fifth receiving portion jointly cover other parts of the second connector except the second insertion portion; and the third receiving portion and the sixth receiving portion jointly cover the wire.

As a further improved technical solution of the present disclosure, a catalyst is coated on a surface of the first-half outer mold to promote mold clamping with the second-half outer mold.

As a further improved technical solution of the present disclosure, a molding material used in the step S2 and/or the step S4 is at least one of polyvinyl chloride (PVC) material, thermoplastic elastomer (TPE) material and thermoplastic polyurethane elastomer (TPU) material.

As a further improved technical solution of the present disclosure, the wire is a flexible flat cable (FFC) or a flexible printed circuit board (FPC); and the wire is of a flat configuration or a round shape.

The present disclosure can also adopt the following technical solution: a method of manufacturing a one-piece connector assembly including following steps:

S1: providing a first semi-finished product of the connector assembly, the first semi-finished product including a first connector, a second connector and a wire connecting the first connector and the second connector;

S2: putting the first semi-finished product into a first forming mold and forming a first-half outer mold in order to form a second semi-finished product; and

S3: putting the second semi-finished product into a second forming mold and forming a second-half outer mold, thereby achieving the one-piece connector assembly. The one-piece configuration means that the first-half outer mold and the second-half outer mold have no gaps between the wire and the first and the second connectors.

As a further improved technical solution of the present disclosure, the first-half outer mold in the step S2 includes a first receiving portion to partially cover the first connector, a second receiving portion to partially cover the second connector, and a third receiving portion to partially cover the wire.

As a further improved technical solution of the present disclosure, the second-half outer mold in the step S3 includes a fourth receiving portion to partially cover the first connector, a fifth receiving portion to partially cover the second connector, and a sixth receiving portion to partially cover the wire.

As a further improved technical solution of the present disclosure, the first connector includes a first insertion portion, the second connector includes a second insertion portion, the first receiving portion and the fourth receiving portion jointly cover other parts of the first connector except the first insertion portion, the second receiving portion and the fifth receiving portion jointly cover other parts of the second connector except the second insertion portion; and the third receiving portion and the sixth receiving portion jointly cover the wire.

As a further improved technical solution of the present disclosure, a catalyst is coated on a surface of the first-half outer mold to promote mold clamping with the second-half outer mold.

As a further improved technical solution of the present disclosure, a molding material used in the step S2 and/or the step S3 is at least one of polyvinyl chloride (PVC) material, thermoplastic elastomer (TPE) material and thermoplastic polyurethane elastomer (TPU) material.

As a further improved technical solution of the present disclosure, the wire is a flexible flat cable (FFC) or a flexible printed circuit board (FPC); and the wire is of a flat configuration or a round shape.

Compared with the prior art, the present disclosure forms a first-half outer mold to cover the first semi-finished product, then forms a second-half outer mold, and finally achieve the one-piece connector assembly after the first-half mold and the second-half mold are closed. By doing that, it reduces the difficulty of each forming. In addition, since the wire can be covered and protected by the first-half outer mold, the wire bias during the second forming is not easy to occur and the yield of the product is improved.

### BRIEF DESCRIPTION OF DRAWINGS

FIG. 1 is a schematic perspective view of a first semi-finished product in accordance with a first embodiment of the present disclosure;

FIG. 2 is a perspective schematic view of a first-half outer mold;

FIG. 3 is a perspective schematic view of a second semi-finished product obtained by assembling the first semi-finished product in FIG. 1 and the first-half outer mold in FIG. 2;

FIG. 4 is a perspective schematic view of a one-piece connector assembly obtained by performing a second molding to the second semi-finished product in FIG. 3;

FIG. 5 is a schematic flowchart showing a method of manufacturing the one-piece connector assembly in accordance with an embodiment of the present disclosure;

FIG. 6 is a perspective schematic view of a first semi-finished product in accordance with a second embodiment of the present disclosure;

FIG. 7 is a perspective schematic view of a second semi-finished product obtained by putting the first semi-finished product in FIG. 6 into a first forming mold;

FIG. 8 is a perspective schematic view of a one-piece connector assembly obtained by putting the second semi-finished product in FIG. 7 into a second forming mold;

FIG. 9 is a schematic flow chart showing a method of manufacturing the one-piece connector assembly in accordance with another embodiment of the present disclosure;

FIG. 10 is a schematic perspective view of a first semi-finished product in accordance with a third embodiment of the present disclosure;

FIG. 11 is a perspective schematic view of a first-half outer mold;

FIG. 12 is a perspective schematic view of a second semi-finished product obtained by assembling the first semi-finished product in FIG. 10 and the first-half outer mold in FIG. 11;

FIG. 13 is a perspective schematic view of a one-piece connector assembly obtained by performing a second molding to the second semi-finished product in FIG. 12; and

FIG. 14 is a schematic perspective view of a one-piece connector assembly in accordance with another embodiment of the present disclosure.

### DETAILED DESCRIPTION

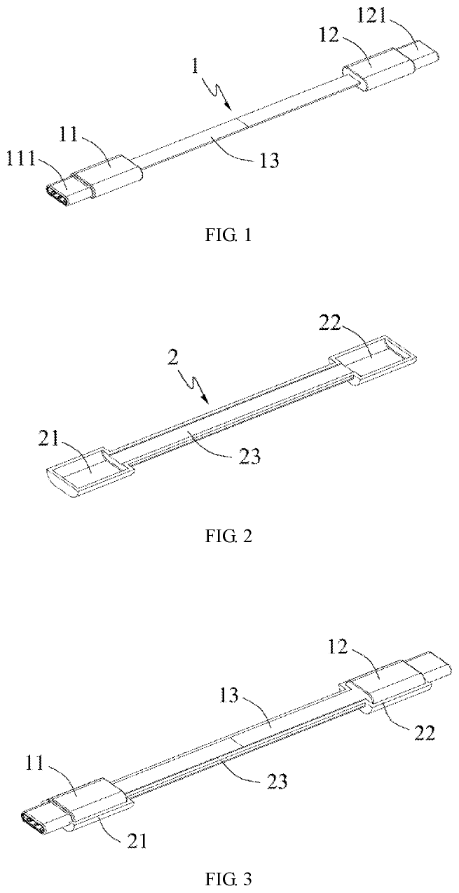

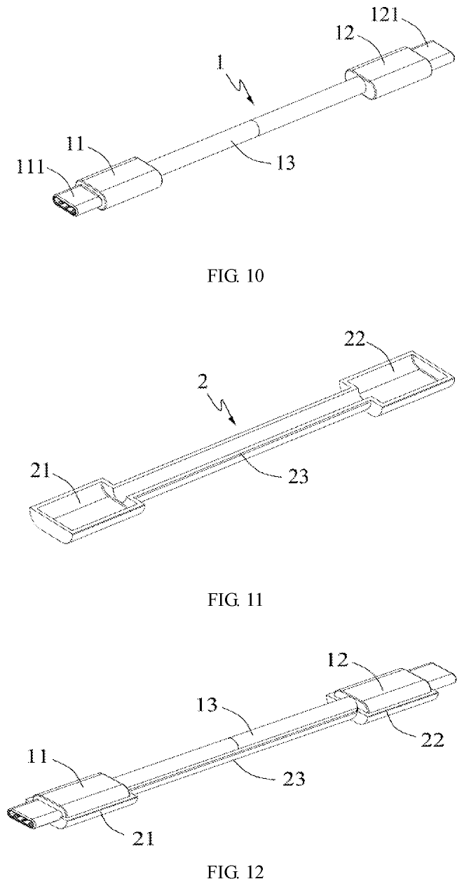

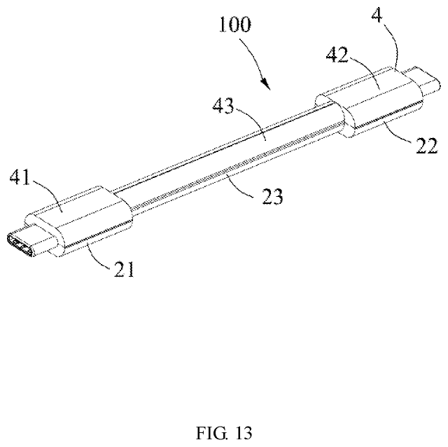

Please refer to FIGS. 1 to 5 and FIGS. 10 to 13, the present disclosure discloses a method of manufacturing a one-piece connector assembly 100. The method includes following steps:

S1: providing a first semi-finished product 1 of the connector assembly 100, the first semi-finished product 1 including a first connector 11, a second connector 12 and a wire 13 connecting the first connector 11 and the second connector 12;

S2: providing a molded first-half outer mold 2;

S3: assembling the first semi-finished product 1 and the first-half outer mold 2 together to form a second semi-finished product 3; and

S4: putting the second semi-finished product 3 into a forming mold and forming a second-half outer mold 4, thereby achieving the one-piece connector assembly 100.

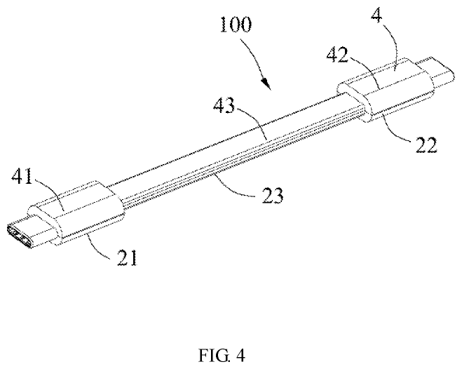

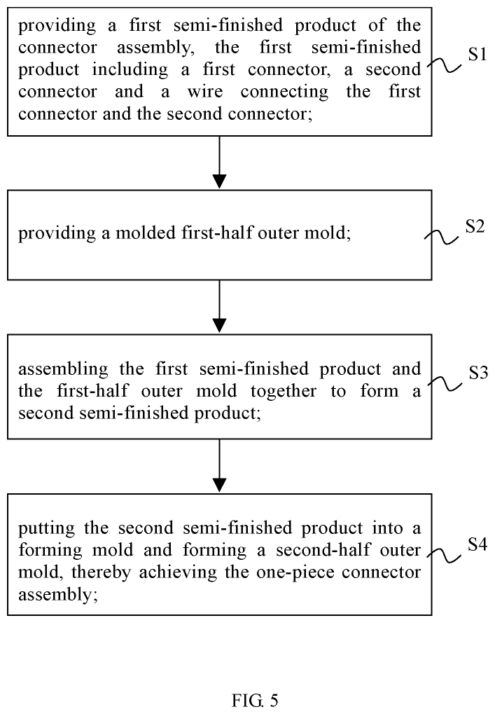

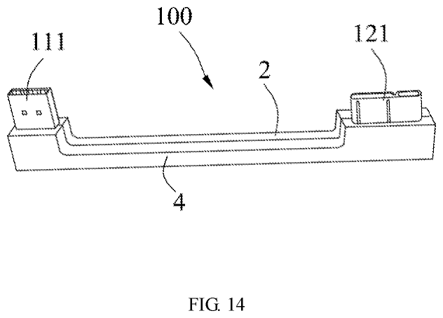

In the step S1, the first connector 11 is provided with a first insertion portion 111, and the second connector 12 is provided with a second insertion portion 121. The first connector 11 and the second connector 12 may be the same or different connectors. The first insertion portion 111 and the second insertion portion 121 are used to cooperate with a mating connector (not shown). As shown in FIG. 4, in an embodiment of the present disclosure, both the first connector 11 and the second connector 12 are straight connectors. As shown in FIG. 14, in another embodiment of the present disclosure, the first connector 11 and the second connector 12 may also be elbow connectors. Of course, in other embodiments, one of the first connector 11 and the second connector 12 is a straight connector, and the other is an elbow connector.

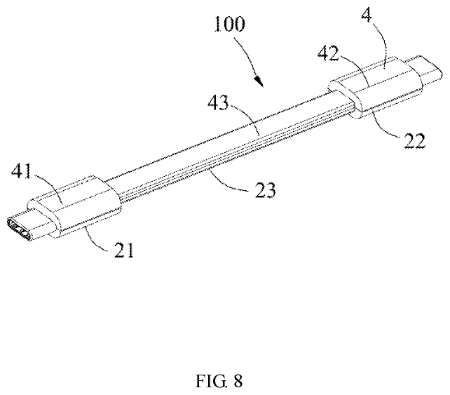

In the step S1, the wire 13 is a flexible flat cable (FFC) or a flexible printed circuit board (FPC). Referring to FIG. 1, the wire 13 is of a flat configuration. Referring to FIG. 8, in another embodiment, the wire 13 may also be a round shape.

In the step S2, the first-half outer mold 2 includes a first receiving portion 21 (such as a groove) to partially cover the first connector 11, a second receiving portion 22 (such as a groove) to partially cover the second connector 12, and a third receiving portion 23 (such as a groove) to partially cover the wire 13.

In the step S3, the first receiving portion 21, the second receiving portion 22 and the third receiving portion 23 support the first connector 11, the second connector 12 and the wire 13 of the first semi-finished product 1, respectively. With this arrangement, during the subsequent molding process, the wire 13 is less prone to deflection so that it is not easy to be exposed, thereby improving the yield of the product.

In the step S4, the second-half outer mold 4 includes a fourth receiving portion 41 (such as a groove) to partially cover the first connector 11, a fifth receiving portion 42 (such as a groove) to partially cover the second connector 12, and a sixth receiving portion 43 (such as a groove) to partially cover the wire 13.

The first receiving portion 21 and the fourth receiving portion 41 jointly cover other parts of the first connector 11 except the first insertion portion 111. The second receiving portion 22 and the fifth receiving portion 42 jointly cover other parts of the second connector 12 except the second insertion portion 121. The third receiving portion 23 and the sixth receiving portion 43 jointly cover the wire 13.

Specifically, in the illustrated embodiment of the present disclosure, the first receiving portion 21 and the fourth receiving portion 41 respectively cover an upper portion and a lower portion of the first connector 11 except the first insertion portion 111. The second receiving portion 22 and the fifth receiving portion 42 respectively cover an upper portion and a lower portion of the second connector 12 except the second insertion portion 121. The third receiving portion 23 and the sixth receiving portion 43 respectively cover an upper portion and a lower portion of the wire 13.

Preferably, in order to achieve sufficient fusion between molding materials during the secondary molding, a surface of the first-half outer mold 2 for clamping with the second-half outer mold 4 may be coated with a catalyst for promoting mold clamping.

The molding material in the step S2 and/or the step S4 is at least one of polyvinyl chloride (PVC) material, thermoplastic elastomer (TPE) material and thermoplastic polyurethane elastomer (TPU) material in order to reduce cost. Of course, in other embodiments, the molding material may also be a relatively high-cost silicone material.

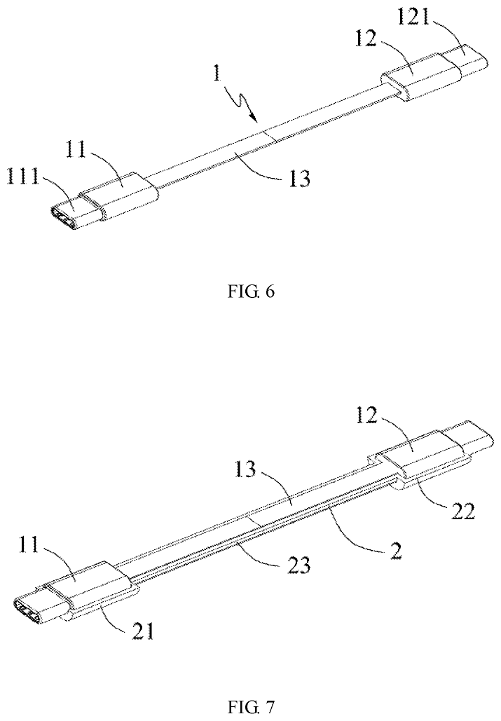

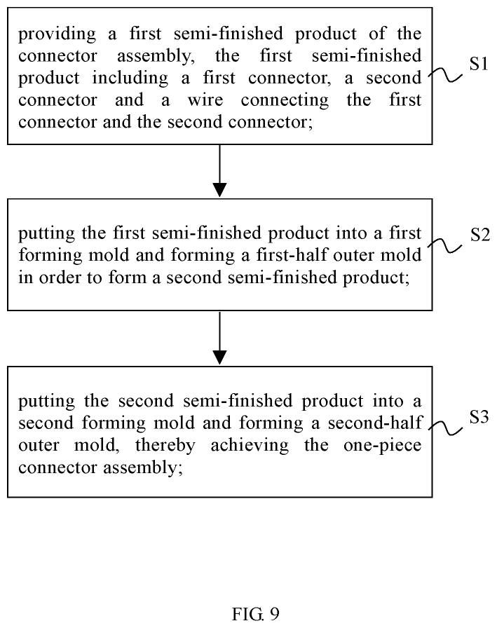

Referring to FIGS. 6 to 9, another embodiment of the present disclosure discloses a method of manufacturing a one-piece connector assembly 100, which includes the following steps:

S1: providing a first semi-finished product 1 of the connector assembly 100, the first semi-finished product 1 including a first connector 11, a second connector 12 and a wire 13 connecting the first connector 11 and the second connector 12; and

S2: putting the first semi-finished product 1 into a first forming mold and forming a first-half outer mold 2 in order to form a second semi-finished product 3;

S3: putting the second semi-finished product 3 into a second forming mold and forming a second-half outer mold 4, thereby achieving the one-piece connector assembly 100.

In the step S1, the first connector 11 is provided with a first insertion portion 111, and the second connector 12 is provided with a second insertion portion 121. The first connector 11 and the second connector 12 may be the same or different connectors. The first insertion portion 111 and the second insertion portion 121 are used to cooperate with a mating connector (not shown). In an embodiment of the present disclosure, both the first connector 11 and the second connector 12 are straight connectors. In another embodiment of the present disclosure, the first connector 11 and the second connector 12 may also be elbow connectors. Of course, in other embodiments, one of the first connector 11 and the second connector 12 is a straight connector, and the other is an elbow connector.

In the step S1, the wire 13 is a flexible flat cable (FFC) or a flexible printed circuit board (FPC). The wire 13 is of a flat configuration or a round shape.

In the step S2, the first-half outer mold 2 includes a first receiving portion 21 to partially cover the first connector 11, a second receiving portion 22 to partially cover the second connector 12, and a third receiving portion 23 to partially cover the wire 13. With this arrangement, during the subsequent molding process, the wire 13 is less prone to deflection so that it is not easy to be exposed, thereby improving the yield of the product.

In the step S3, the second-half outer mold 4 includes a fourth receiving portion 41 to partially cover the first connector 11, a fifth receiving portion 42 to partially cover the second connector 12, and a sixth receiving portion 43 to partially cover the wire 13.

The first receiving portion 21 and the fourth receiving portion 41 jointly cover other parts of the first connector 11 except the first insertion portion 111. The second receiving portion 22 and the fifth receiving portion 42 jointly cover other parts of the second connector 12 except the second insertion portion 121. The third receiving portion 23 and the sixth receiving portion 43 jointly cover the wire 13.

Specifically, in the illustrated embodiment of the present disclosure, the first receiving portion 21 and the fourth receiving portion 41 respectively cover an upper portion and a lower portion of the first connector 11 except the first insertion portion 111. The second receiving portion 22 and the fifth receiving portion 42 respectively cover an upper portion and a lower portion of the second connector 12 except the second insertion portion 121. The third receiving portion 23 and the sixth receiving portion 43 respectively cover an upper portion and a lower portion of the wire 13.

Preferably, in order to achieve sufficient fusion between molding materials during the secondary molding, a surface of the first-half outer mold 2 for clamping with the second-half outer mold 4 may be coated with a catalyst for promoting mold clamping.

The molding material in the step S2 and/or the step S3 is at least one of polyvinyl chloride (PVC) material, thermoplastic elastomer (TPE) material and thermoplastic polyurethane elastomer (TPU) material in order to reduce cost. Of course, in other embodiments, the molding material may also be a relatively high-cost silicone material.

Compared with the prior art, the present disclosure forms a first-half outer mold 2 to cover the first semi-finished product 1, then forms a second-half outer mold 4, and finally achieve the one-piece connector assembly 100 after the first-half mold 2 and the second-half mold 4 are closed. The one-piece configuration means that the outer molds 2 and 4 have no gaps between the wire 13 and the connectors 11 and 12, and usually the outer molds 2 and 4, the wires 13 and the connectors 11 and 12 need to be broken when separating them. With this arrangement, it reduces the difficulty of each forming. In addition, since the wire 13 can be covered and protected by the first-half outer mold which is previously formed, during the second forming, the wire 13 is not likely to be biased, which improves the yield of the product. Besides, the outer molds 2 and 4 have no gaps between the wire 13 and the connectors 11 and 12, so that the connector assembly 100 is not easily broken when pulled by an external force.

The above embodiments are only used to illustrate the present application and not to limit the technical solutions described in the present application. The understanding of this specification should be based on those skilled in the art. Descriptions of directions, such as “top” and “bottom”, although they have been described in detail in the above-mentioned embodiments of the present application, those skilled in the art should understand that modifications or equivalent substitutions can still be made to the application, and all technical solutions and improvements that do not depart from the spirit and scope of the application should be covered by the claims of the application.

What is claimed is:

1. A method of manufacturing a one-piece connector assembly, the method comprising following steps:
S1: providing a first semi-finished product of the connector assembly, the first semi-finished product comprising a first connector, a second connector and a wire connecting the first connector and the second connector;
S2: providing a molded first-half outer mold;
S3: assembling the first semi-finished product and the first-half outer mold together to form a second semi-finished product; and
S4: putting the second semi-finished product into a forming mold and forming a second-half outer mold, thereby achieving the one-piece connector assembly.

2. The method of manufacturing the one-piece connector assembly according to claim 1, wherein the first-half outer mold in the step S2 comprises a first receiving portion to partially cover the first connector, a second receiving portion to partially cover the second connector, and a third receiving portion to partially cover the wire.

3. The method of manufacturing the one-piece connector assembly according to claim 2, wherein the second-half outer mold in the step S4 comprises a fourth receiving portion to partially cover the first connector, a fifth receiving portion to partially cover the second connector, and a sixth receiving portion to partially cover the wire.

4. The method of manufacturing the one-piece connector assembly according to claim 3, wherein the first connector comprises a first insertion portion, the second connector comprises a second insertion portion, the first receiving portion and the fourth receiving portion jointly cover other parts of the first connector except the first insertion portion, the second receiving portion and the fifth receiving portion jointly cover other parts of the second connector except the second insertion portion; and the third receiving portion and the sixth receiving portion jointly cover the wire.

5. The method of manufacturing the one-piece connector assembly according to claim 1, wherein a catalyst is coated on a surface of the first-half outer mold to promote mold clamping with the second-half outer mold.

6. The method of manufacturing the one-piece connector assembly according to claim 1, wherein a molding material used in the step S2 and/or the step S4 is at least one of polyvinyl chloride (PVC) material, thermoplastic elastomer (TPE) material and thermoplastic polyurethane elastomer (TPU) material.

7. The method of manufacturing the one-piece connector assembly according to claim 1, wherein the wire is a flexible flat cable or a flexible printed circuit board.

8. The method of manufacturing the one-piece connector assembly according to claim 1, wherein the wire is of a flat configuration or a round shape.

9. A method of manufacturing a one-piece connector assembly, the method comprising following steps:
S1: providing a first semi-finished product of the connector assembly, the first semi-finished product comprising a first connector, a second connector and a wire connecting the first connector and the second connector;
S2: putting the first semi-finished product into a first forming mold and forming a first-half outer mold in order to form a second semi-finished product;
S3: putting the second semi-finished product into a second forming mold and forming a second-half outer mold, thereby achieving the one-piece connector assembly.

10. The method of manufacturing the one-piece connector assembly according to claim 9, wherein the first-half outer mold in the step S2 comprises a first receiving portion to partially cover the first connector, a second receiving portion to partially cover the second connector, and a third receiving portion to partially cover the wire.

11. The method of manufacturing the one-piece connector assembly according to claim 10, wherein the second-half outer mold in the step S3 comprises a fourth receiving portion to partially cover the first connector, a fifth receiving portion to partially cover the second connector, and a sixth receiving portion to partially cover the wire.

12. The method of manufacturing the one-piece connector assembly according to claim 11, wherein the first connector comprises a first insertion portion, the second connector comprises a second insertion portion, the first receiving portion and the fourth receiving portion jointly cover other parts of the first connector except the first insertion portion, the second receiving portion and the fifth receiving portion jointly cover other parts of the second connector except the second insertion portion; and the third receiving portion and the sixth receiving portion jointly cover the wire.

13. The method of manufacturing the one-piece connector assembly according to claim 9, wherein a catalyst is coated on a surface of the first-half outer mold to promote mold clamping with the second-half outer mold.

14. The method of manufacturing the one-piece connector assembly according to claim 9, wherein a molding material used in the step S2 and/or the step S3 is at least one of polyvinyl chloride (PVC) material, thermoplastic elastomer (TPE) material and thermoplastic polyurethane elastomer (TPU) material.

15. The method of manufacturing the one-piece connector assembly according to claim 9, wherein the wire is a flexible flat cable or a flexible printed circuit board.

16. The method of manufacturing the one-piece connector assembly according to claim 9, wherein the wire is of a flat configuration or a round shape.
